(19) United States
(12) Patent Application Publication
(10) Pub. No.: US 2006/0070636 A1
(43) Pub. Date: Apr. 6, 2006

(54) Toothpick device

(76) Inventor: Cassie Peters JR., Phoenix, AZ (US)

Correspondence Address: FRANK J. MCGUE, 10801 N. 32ND STREET SUITE 5, PHOENIX, AZ, 85028, US

(21) Appl. No.: 10/958,084

(22) Filed: Oct. 4, 2004

(51) Int. Cl. A61C 15/00

(52) U.S. Cl. 132/324

(57) ABSTRACT

A toothpick device for cleaning teeth includes a toothpick. The toothpick is comprised of two separable portions and has at least one pointed end. A length of dental floss is provided with each end of the dental floss being secured to one of the two portions of the toothpick. The dental floss is wound for storage between said two portions whereby separating the two portions unwinds the dental floss for use.

### TECHNICAL FIELD

This invention relates generally to the field of toothpicks, and, more particularly, to an improved toothpick having floss associated therewith.

### BACKGROUND OF THE INVENTION

Dental floss is a mainstay of care for the teeth. The American Dental Association (ADA) recommends brushing twice a day and cleaning between the teeth with floss or interdental cleaners once each day to remove plaque from all tooth surfaces. Plaque is responsible for both tooth decay and gum disease. Floss helps remove food debris caught between teeth that may not be rinsed or brushed away.

However, when away from the home, the majority of individuals do not carry floss for dental care. Instead, to remove food debris from between the teeth, persons often use toothpicks which are ubiquitous in restaurants across the United States. However, while toothpicks are useful for the larger food debris, it is not very satisfactory for smaller food debris which may not even be felt. In addition, reaching between back teeth such as molars is very difficult with a toothpick. Thus, there is a need for a device to make floss as common as toothpicks for individual use. The present invention meets this need.

United Kingdom GB 2289845 entitled “Toothpick Containing Dental Floss” which published on Dec. 6, 1995 filed by Lara provides a breakable toothpick containing dental floss.

U.S. Pat. No. 6,102,051 entitled “Flossing Kit” which issued on Aug. 15, 2000 to Neves shows a toothpick containing a supply of dental floss wrapped about one end. Neves leaves one end of said floss free.

U.S. Pat. No. 4,633,892 entitled “Oral Hygiene Device” which issued on Jan. 6, 1987 to Charatan discloses an oral hygiene device comprising a hollow housing (not a toothpick) containing dental floss which may be broken into two portions which serve as handles for manipulating the floss.

U.S. Pat. No. 5,253,661 entitled “Composite Oral Cleaning Device” which issued on Oct. 19, 1993 to Alonzo has an oral cleaning apparatus with one pointed tip and a spool or cleat region suitable for wrapping and holding a supply of dental floss. The floss is not attached to the device except for winding around said apparatus.

None of the known prior art disclose the combination set forth herein.

### SUMMARY OF THE INVENTION

It is an object of this invention to provide an improved toothpick in combination with dental floss.

It is an further object of this invention to provide an improved toothpick and floss combination which is easily to use and convenient.

Further objects and advantages of the invention will become apparent as the following description proceeds and the features of novelty which characterize this invention will be pointed out with particularity in the claims annexed to and forming a part of this specification.

### BRIEF DESCRIPTION OF THE DRAWINGS

The present invention may be more readily described by reference to the accompanying drawings in which:

FIG. 1 is a side view of one embodiment of a toothpick and floss combination of the present invention;

FIG. 1B is a side view of the embodiment of FIG. 2 showing the toothpick broken to dispense floss therefrom;

FIG. 2 is a perspective view of the embodiment of FIG. 2 in use by a woman;

FIG. 3 is partial cross sectional view of another embodiment of a toothpick and floss combination of the present invention;

FIG. 3B is a partial cross sectional view of the combination of FIG. 4 showing the withdrawal of the floss therefrom;

FIG. 4 is partial cross sectional view of still another embodiment of a toothpick and floss combination of the present invention;

FIG. 4B is a partial cross sectional view of the combination of FIG. 4 showing the withdrawal of the floss therefrom;

FIG. 5 is a partial cross sectional view of a further embodiment of a toothpick and floss combination of the present invention; and

FIG. 5B is a partial cross sectional view of the combination of FIG. 5 showing withdrawal of the floss therefrom.

### DESCRIPTION OF THE PREFERRED EMBODIMENT

A toothpick device for cleaning teeth includes a toothpick and a length of dental floss 16. The toothpick is comprised of two separable portions and has at least one pointed end. The length of dental floss 16 is provided with each end of dental floss 16 being secured to one of the two portions of the toothpick. The dental floss is wound for storage between said two portions whereby separating the two portions unwinds the dental floss for use.

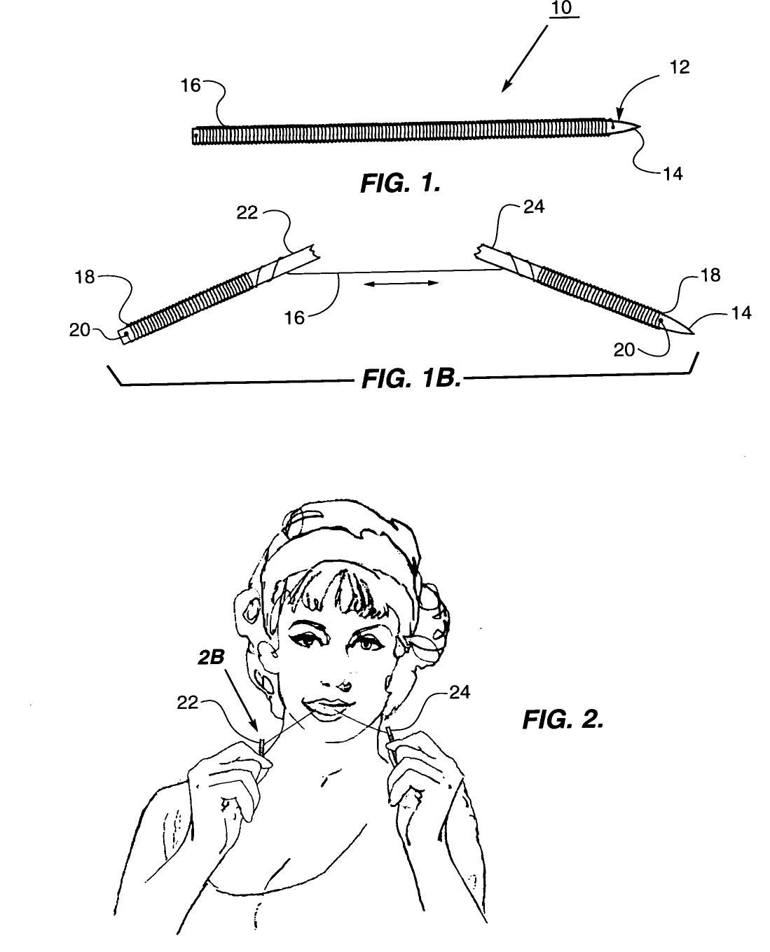

Referring more particularly to the drawings by characters of reference, FIGS. 1-2 disclose combinations of features which constitute the components of one embodiment of a toothpick device 10 of the present invention. In the presently preferred embodiment, toothpick device 10 comprises a toothpick 12 having a pointed end 14. A length of dental floss 16 is wound about the exterior of toothpick 12. Both ends 18 of dental floss 16 are secured to toothpick 12, preferably by an adhesive 20.

In use, the user may use point 14 to larger particles of food debris from between his or her teeth in a manner well known in the art. When flossing is desired, the user simply breaks toothpick 12 thereby creating the separable portions which are toothpick halves 22 and 24 as shown in FIG. 1B. To facilitate breakage at the mid-point of said toothpick 12, said toothpick has score lines 23. As halves 22 and 24 are separated, dental floss 16 unwinds for use. As best seen in FIG. 2, each half 20 and 22 acts as a handle while dental floss 16 is applied to the user's teeth.

The embodiment of FIGS. 1-2 is best suited for standard wooden toothpick 12 though use with plastic variants is certainly conceivable. In addition, those skilled in the art will recognize that use of an adhesive 20 is exemplary in nature, and that other methods of securing floss 16 to toothpick 12 are certainly contemplated in the scope of the present disclosure.

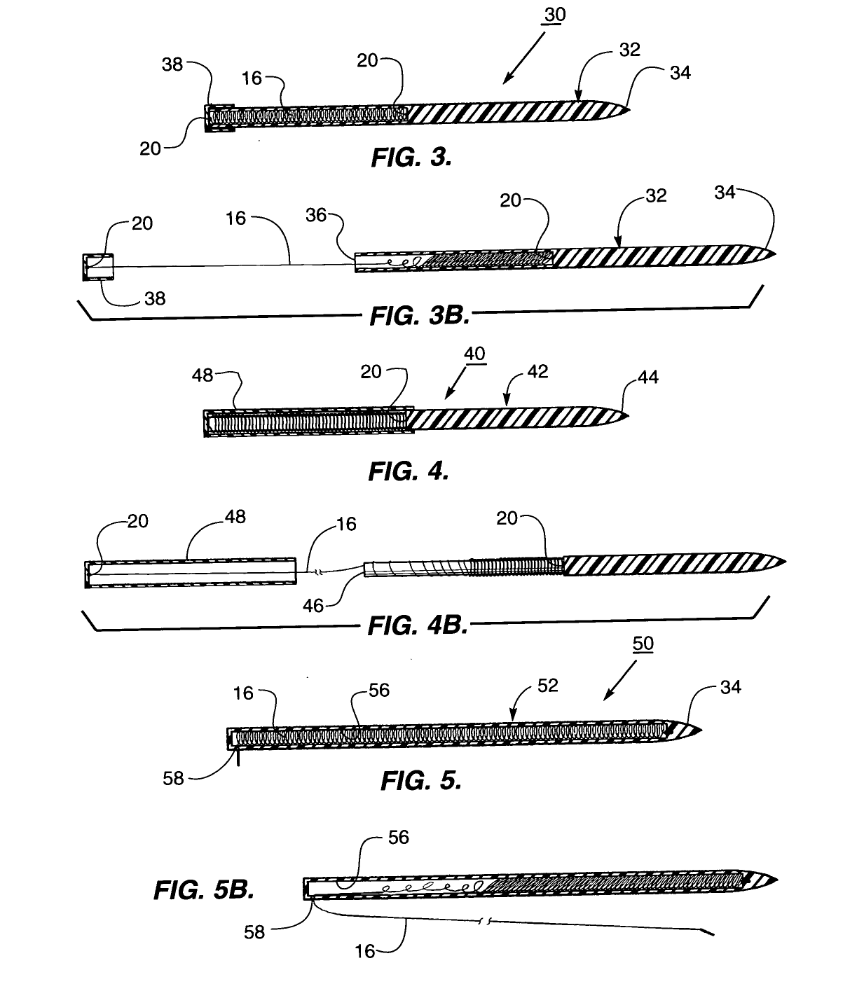

Other embodiments of the invention are shown in FIGS. 3, 3B, 4, 4B, 5 and 5B. In FIGS. 3, a hollow toothpick device 30 comprises a toothpick portion 32 having a pointed end 34 at one end thereof and a cavity 36 at the opposing end. Toothpick portion 32 is one of the separable portions. A quantity of dental floss 16 is wound and contained within cavity 36. The second separable portion is a short cap 38 which is releasably secured to toothpick portion 32 and which covers the opening of cavity 36. One end of dental floss 16 is secured to toothpick portion 32 within cavity 36 by, for example, an adhesive 20. The other end of dental floss 16 is secured to cap 38, again, for example, by an adhesive 20.

In use, the user may use pointed end 34 to larger particles of food debris from between his or her teeth in a manner well known in the art. When flossing is desired, the user simply releases short cap 38 from engagement with toothpick portion 32 thereby separating said short cap 38 and toothpick portion 32 as shown in FIG. 3B. As short cap 38 and toothpick portion 32 are separated, dental floss 16 unwinds from cavity 36 for use. Short cap 38 and toothpick portion 32 each acts as a handle while dental floss 16 is applied to the user's teeth.

The embodiment of FIGS. 3, 3B is best suited for plastic because of the difficulty of hollowing out wood when thin as toothpicks generally are. However, use with other materials is certainly conceivable.

In FIG. 4, a toothpick device 40 comprises a solid toothpick portion 42 having a pointed end 44 at one end thereof and a blunt end 46 at the other end thereof. Solid toothpick portion 42 is one of the separable portions. A quantity of dental floss 16 is wound about solid toothpick portion 42 proximate to blunt end 46. A sleeve 48, said sleeve being the second separable portion, is releasably secured over said wound dental floss 16 and solid toothpick portion 42. One end of dental floss 16 is secured to solid toothpick portion 42 by, for example, an adhesive 20. The other end of dental floss 16 is secured to sleeve 48, again, for example, by an adhesive 20.

In use, the user may use pointed end 34 to larger particles of food debris from between his or her teeth in a manner well known in the art. When flossing is desired, the user simply releases sleeve 48 from engagement with wound dental floss 16 and solid toothpick portion 42 thereby separating said sleeve 48 and solid toothpick portion 42 as shown in FIG. 4B. As sleeve 48 and toothpick portion 42 are separated, dental floss 16 unwinds around solid toothpick portion 42 for use. Sleeve 48 and solid toothpick portion 42 each acts as a handle while dental floss 16 is applied to the user's teeth in the usual manner. The embodiment of FIG. 4 may be easily manufactured from plastic or wood or any other suitable substance. In addition, sleeve 48 provides a better handle for the user's convenience than short cap 38.

In addition, those skilled in the art will recognize that short cap 38 and sleeve 48 can be releasably secured to toothpick portions 32 and 42, respectively, by a plethora of methods, including, but not limited to, screw on, snap on, stick on adhesives and the like.

In FIG. 5, a hollow toothpick 50 comprises a toothpick portion 52 having a pointed end 54 at one end thereof Toothpick 50 is hollow with a cylindrical cavity 56 contained therein. Opposite pointed end an access hole 58 is provided connecting cylindrical cavity 56 and the exterior of portion 52. Toothpick portion 52 is one of the separable portions. A quantity of dental floss 16 is wound and contained within cavity 56. The second separable portion is a short pin 59 which is extends into cavity 56 via hole 58. One end of dental floss 16 is secured to toothpick portion 52 within cavity 36 by, for example, an adhesive 20. The other end of dental floss 16 is secured to pin 59, again, for example, by an adhesive 20.

In use, the user may use pointed end 34 to larger particles of food debris from between his or her teeth in a manner well known in the art. When flossing is desired, the user simply releases short pin 59 from engagement with hole 58 thereby separating said short pin 58 and toothpick portion 52 as shown in FIG. 5B. As short pin 59 and toothpick portion 52 are separated, dental floss 16 unwinds from cavity 56 for use. Short pin 58 and toothpick portion 52 each acts as a handle while dental floss 16 is applied to the user's teeth.

The embodiment of FIGS. 5, 5B is best suited for plastic because of the difficulty of hollowing out wood when thin as toothpicks generally are. However, use with other materials is certainly conceivable.

Further, those skilled in the art will recognize that the embodiments discussed herein can be packaged in many different ways. For example, said devices 10 can be packaged in individual glassine envelopes or simply provided in bulk in dispensers or boxes as desired.

Although only certain embodiments have been illustrated and described, it will be apparent to those skilled in the art that various changes and modifications may be made therein without departing from the spirit of the invention or from the scope of the appended claims.

What is claimed is:

1. A toothpick device for cleaning teeth comprises:
a toothpick comprised of two separable portions, the toothpick having at least one pointed end;
a length of dental floss, each end of the dental floss being secured to one of the two portions of the toothpick, the dental floss being wound for storage between said two portions whereby separating the two portions unwinds the dental floss for use.

2. The toothpick device of claim 1 wherein the dental floss is secured to the exterior of the toothpick, the two portions of the toothpick being two halves thereof, the two halves being separable by breaking said toothpick between the ends of the dental floss.

3. The toothpick device of claim 2 comprised of wood.

4. The toothpick device of claim 1 wherein the two portions of the toothpick are a toothpick portion and a sleeve, the toothpick portion having a blunt end and the pointed end, the dental floss being wound about the exterior of the toothpick portion abutting the blunt end, the sleeve being releasably secured over said wound dental floss.

5. The toothpick device of claim 1 wherein the two portions are a hollow toothpick portion and a cap, the toothpick portion having a blunt end and the pointed end, the hollow toothpick portion having a cavity at the blunt end, the dental floss being wound within the cavity, the short cap being releasably secured to the hollow toothpick portion and covering the cavity, one end of the dental floss being secured within the cavity and the other end being secured to the cap.

6. The toothpick device of claim 1 wherein the two portions are a hollow toothpick portion and a pin, the toothpick portion having a blunt end and the pointed end, the hollow toothpick portion having a cylindrical cavity contained therein, the toothpick portion having an access hole extending from cylindrical cavity to the exterior of the toothpick portion, the dental floss being wound within the cavity, the short pin extending through the access hole, one end of the dental floss being secured within the cavity and the other end being secured to the short pin.
